(19) United States
(12) Patent Application Publication
(10) Pub. No.: US 2014/0065966 A1
(43) Pub. Date: Mar. 6, 2014

(54) FEED-FORWARD INTERACTION WITH A NETWORK INTERFACE

(71) Applicant: APPLE INC., Cupertino, CA (US)

(72) Inventor: Pradeep S. Sharma, Cupertino, CA (US)

(73) Assignee: APPLE INC., Cupertino, CA (US)

(21) Appl. No.: 13/628,316

(22) Filed: Sep. 27, 2012

Related U.S. Application Data
(60) Provisional application No. 61/695,663, filed on Aug. 31, 2012.

(51) Int. Cl. H04B 7/00

(52) U.S. Cl. 455/41.2

(57) ABSTRACT

In order to facilitate timely communication between electronic devices via a previously established communication link, a feed-forward technique may be used to transition the communication link from a power-saving mode to an active mode before a software application executing on one of the electronic devices attempts to communicate information. For example, if the software application determines that the information needs to be communicated to another electronic device at a future time, the software application provides a command to an interface circuit in the electronic device to transition the communication link to the active mode. After receiving a confirmation that the communication link is in the active mode, the software application provides the information to the interface circuit for communication to the other electronic device. In this way, the information can be communicated at the time without a time delay associated with the transition.

### CROSS REFERENCE TO RELATED APPLICATION

This application claims priority under 35 U.S.C. §119(e) to U.S. Provisional Application Ser. No. 61/695,663, entitled “Feed-Forward Interaction with a Network Interface,” by Pradeep S. Sharma, Attorney docket number APL-P16861USP1, filed on Aug. 31, 2012, the contents of which is herein incorporated by reference.

### BACKGROUND

1. Field

The described embodiments relate to techniques for feed-forward interaction between a software application executing on an electronic device and a network interface in the electronic device.

2. Related Art

The increasing functionality of electronic devices, such as cellular telephones, is leading to a significant increase in their popularity. In turn, these trends are causing an increase in the number of software applications that are available for use on these electronic devices. One recent type of popular software application is an intelligent personal assistant and knowledge manager, such as Siri (from Apple Inc. of Cupertino, Calif.).

In addition, many modern electronic devices include a networking subsystem that is used to wirelessly communicate with other electronic devices. For example, these electronic devices can include a networking subsystem with a cellular network interface (UMTS, LTE, etc.), a wireless local area network interface (e.g., a wireless network such as described in the Institute of Electrical and Electronics Engineers (IEEE) standards 802.11 or Bluetooth™ from the Bluetooth Special Interests Group of Kirkland, Wash.), and/or other types of wireless interfaces.

However, it can be difficult to seamlessly integrate the wireless communication capabilities of these electronic devices with the software applications that execute on the electronic devices. For example, if no data packets are communicated with another electronic device using an established Bluetooth™ connection during a time interval, a networking subsystem in an electronic device may transition the Bluetooth™ connection to a power-saving operation mode (which is sometimes referred to as a ‘sniff’ mode). However, if a software application executing on the electronic device subsequently attempts to communicate information to the other electronic device via the Bluetooth™ connection, there is typically a time delay of 1-2 seconds while the networking subsystem transitions from the power-saving mode to an active operation mode (which may establish a synchronous connection-oriented link between the electronic device and the other electronic device). This time delay degrades the user experience.

### SUMMARY

The described embodiments relate to an electronic device. This electronic device includes: an antenna; an interface circuit, coupled to the antenna, that communicates with another electronic device; a processor coupled to the interface circuit; and memory that stores a program module that is executed by the processor. The program module facilitates communication between the electronic device and another electronic device that was previously identified by the electronic device. In particular, when the program module determines that there is a need to communicate information with the other electronic device at a future time using a communication link between the electronic device and the other electronic device that is currently in a power-saving mode, the program module provides a command to the interface circuit to transition the communication link to an active mode. After receiving a confirmation from the interface circuit that the communication link is in the active mode, the program module provides the information to the interface circuit for communication to the other electronic device at the time without a time delay associated with transitioning the communication link from the power-saving mode to the active mode.

Note that communicating the information in the active mode may involve a communication protocol, such as Bluetooth™. However, another communication protocol may be used.

Moreover, in the active mode the communication link may include: a synchronous connection-oriented link and/or an extended synchronous connection-oriented link. Alternatively or additionally, in the active mode the communication link may be compatible with an advanced audio distribution profile. More generally, in the active mode the communication link may be compatible with and/or use a wide variety of communication protocols.

Furthermore, in the power-saving mode the communication link may be compatible with a sniff mode in which the electronic device listens for specific commands from the other electronic device.

Another embodiment provides a method that includes at least some of the operations performed by the electronic device.

Another embodiment provides a computer-program product for use with the electronic device. This computer-program product includes instructions for at least some of the operations performed by the electronic device.

### BRIEF DESCRIPTION OF THE FIGURES

FIG. 1 is a block diagram illustrating electronic devices wirelessly communicating in accordance with an embodiment of the present disclosure.

FIG. 2 is a flow diagram illustrating a method for communicating between an electronic device and another electronic device in accordance with an embodiment of the present disclosure.

FIG. 3 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to facilitate timely communication between electronic devices via a previously established communication link, a feed-forward technique may be used to transition the communication link (including interface circuits in the electronic devices) from a power-saving mode to an active mode before a software application or a program module executing on or in an environment of one of the electronic devices attempts to communicate information via the communication link. For example, if the software application determines that the information needs to be communicated to another electronic device at a future time, the software application provides a command to an interface circuit in the electronic device to transition the communication link to the active mode. After receiving a confirmation from the interface circuit that the communication link is in the active mode, the software application provides the information to the interface circuit for communication to the other electronic device. In this way, the information can be communicated at the time without a time delay associated with transitioning the communication link from the power-saving mode to the active mode.

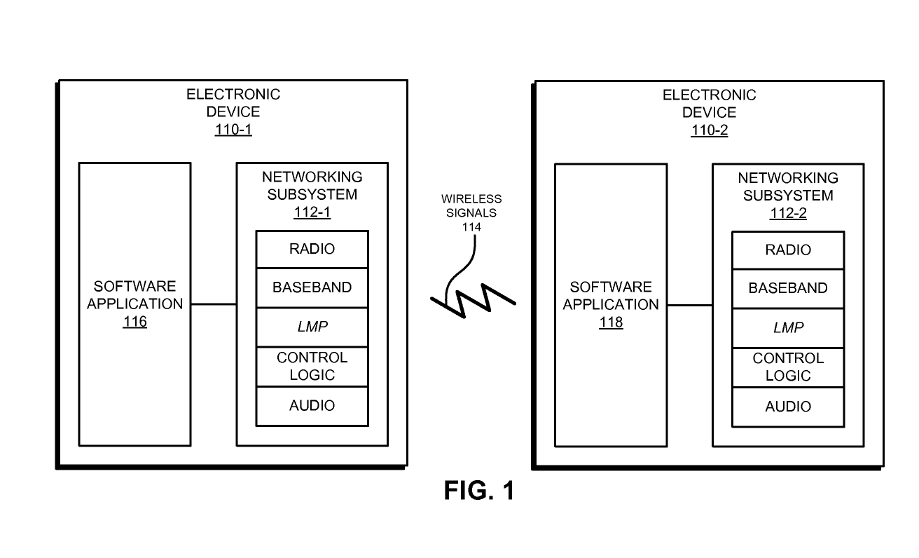

The communication between the electronic devices is shown in FIG. 1, which presents a block diagram illustrating electronic devices 110 wirelessly communicating. In particular, these electronic devices may wirelessly communicate while: discovering one another by scanning wireless channels, transmitting and receiving advertising frames on wireless channels, establishing connections (for example, by transmitting connect requests), and/or transmitting and receiving packets (which may include the commands and/or the information as payloads).

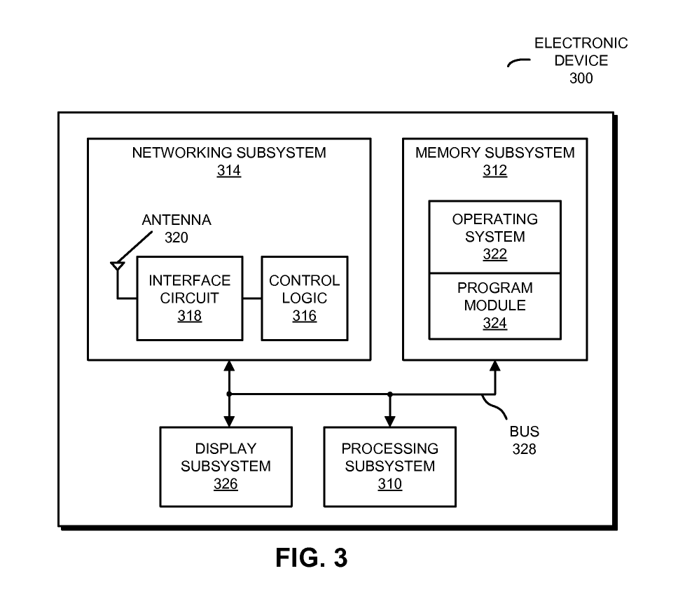

As described further below with reference to FIG. 3, each of electronic devices 110 may include subsystems, such as a networking subsystem, a memory subsystem and a processor subsystem. In addition, electronic devices 110 may include radios in networking subsystems 112. More generally, electronic devices 110 can include (or can be included within) any electronic devices with the networking subsystems that enable electronic devices 110 to wirelessly communicate with another electronic device. This can comprise: transmitting advertising frames on wireless channels to enable electronic devices to make initial contact, followed by exchanging subsequent data/management frames (such as connect requests) to establish a connection; configuring security options (e.g., IPSEC); transmitting and receiving packets or frames via the connection, etc.

As can be seen in FIG. 1, wireless signals 114 (represented by a jagged line) are transmitted from a radio in electronic device 110-1. These wireless signals 114 are received by a radio in electronic device 110-2.

In the described embodiments, processing a packet or frame in either of electronic devices 110-1 and 110-2 includes: receiving wireless signals 114 with the packet or frame; decoding/extracting the packet or frame from received wireless signals 114 to acquire the packet or frame; and processing the packet or frame to determine information contained in the packet or frame (such as the command or the information in the payload).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

In the discussion that follows, a Bluetooth™ (from the Bluetooth Special Interests Group of Kirkland, Wash.) communication protocol is used as an illustration of a communication technique used when communicating information between electronic devices 110. However, in other embodiments another type of wireless communication technique is used, such as those described in the Institute of Electrical and Electronics Engineers (IEEE) standards 802.11 (e.g., Wi-Fi).

After a Bluetooth™ connection or communication link has been established between electronic devices 110, one or more software applications executing on or in environments of electronic devices 110 may communicate information using this communication link. For example, when data or voice packets are communicated between electronic devices 110, the communication link may operate in an active mode (e.g., the communication link may be a synchronous connection-oriented link and/or an extended synchronous connection-oriented link). In some embodiments, the communication link is compatible with an advanced audio distribution profile (A2DP). More generally, in the active mode the communication link may be compatible with and/or use a wide variety of communication protocols.

However, when data or voice packets are not being communicated between electronic devices 110, the communication link (as well as networking subsystems 112 in electronic devices 110) may transition from the active mode to a power-saving mode (such as a Bluetooth™ sniff mode in which a pairing of electronic devices 110 remains in logic and electronic devices 110 ‘sleep’ but periodically ‘wake up’ to transmit and receive pilots at certain times to confirm that electronic devices 110 are still present). While this reduces the power consumption of electronic devices 110, there is often a time delay when transitioning the communication link back from the power-saving mode to the active mode. Thus, if the communication link is in the power-saving mode and a software application executing on or in an environment of one of electronic devices 110 attempts to communicate information to the other of electronic devices 110, there may be a significant time delay (such as 1-2 s) before the communication link is available. This time delay may frustrate users and, thus, may degrade the user experience, thereby adversely impacting sales and customer retention.

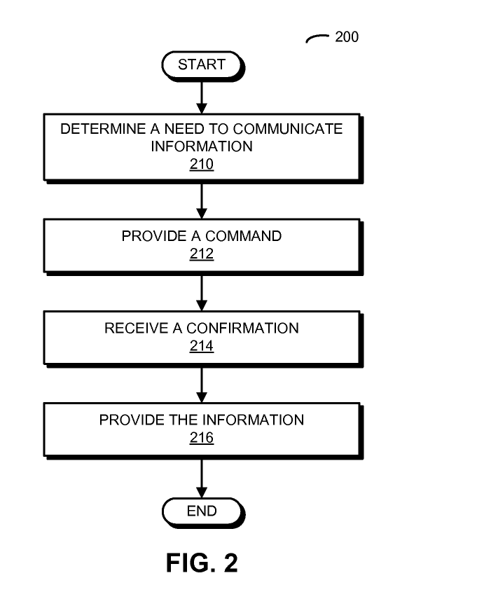

This problem may be addressed using a feed-forward technique in which the software application alerts the networking subsystem prior to attempting to communicate information so that the communication link has sufficient time to transition from the power-saving mode to the active mode. The feed-forward technique is shown in FIG. 2, which presents a flow diagram illustrating a method 200 for communicating between an electronic device (such as electronic device 300 in FIG. 3) and another electronic device that was previously identified by the electronic device. During operation, a program module executing on or in an environment of the electronic device determines that there is a need to communicate information (operation 210) with the other electronic device at a future time using a communication link between the electronic device and the other electronic device that is currently in a power-saving mode. In response, the program module provides a command (operation 212) to an interface circuit in the electronic device to transition the communication link to an active mode. After receiving a confirmation (operation 214) from the interface circuit that the communication link is in the active mode, the program module provides the information (operation 216) to the interface circuit for communication to the other electronic device at, before or proximate to the time without a time delay associated with transitioning the communication link from the power-saving mode to the active mode.

In this way, the program module may facilitate timely communication between the electronic device and the other electronic device, thereby reducing user frustration and improving the user experience, which may improve sales of the electronic device and/or a software application associated with or that includes the program module, as well as customer retention.

In some embodiments of method 200, there may be additional or fewer operations. Moreover, the order of the operations may be changed, and/or two or more operations may be combined into a single operation.

Referring back to FIG. 1, in an exemplary embodiment method 200 (FIG. 2) allows a software application (such as software application 116 executing on or in an environment of electronic device 110-1) to communicate information to a different software application or another instance of the software application (such as software application 118 executing on or in an environment of electronic device 110-2) via a communication link, such as a Bluetooth™ communication link. In particular, a software application such as Maps or Sirion an electronic device that uses iOS (from Apple Inc. of Cupertino, Calif.) may be used to transmit and receive packets via the Bluetooth™ communication link.

However, when not in use for a few seconds (i.e., when packets are not communicated between electronic devices 110), the Bluetooth™ communication link may transition to the power-saving mode (such as the sniff mode). While the Bluetooth™ communication link is in the power-saving mode, software application 116 can trigger voice prompts that cause the Bluetooth™ communication link to transition from the power-saving mode to the active mode. This transition can take up to 1-2 s to occur which can degrade the user experience because the initial voice prompts may seem to be incomplete to the user.

For example, a user of electronic device 110-1 may use a Maps software application to get directions to a destination. In particular, as the user drives, the Maps software application may provide turn-by-turn directions. If the user is on a freeway, the Maps software application may direct the user to exit the freeway after 15 miles. Because there may not be any subsequent voice prompts transmitted for several minutes, the Bluetooth™ communication link may transition to the power-saving mode. Then, when the user is around 0.5 miles from the exit, the Maps software application may trigger a voice prompt immediately, but the Bluetooth™ communication link may take a while to transition back to the active mode so the initial data associated with the voice prompt may be lost.

This problem may be addressed using the feed-forward technique. In particular, software application 116 (e.g., Maps or Siri) may coordinate with networking subsystem 112-1 in electronic device 110-1 (such as the baseband control logic and/or the radio-frequency transceiver interface circuit) to bring up the Bluetooth™ communication link (i.e., to transition back to the active mode) before prompting the voice command. This may make the user experience more seamless so that the user does not notice any missed or incomplete voice prompts.

In an exemplary embodiment, software application 116 determines that, at a future time, information will need to be communicated to software application 118 (and, more generally, to electronic device 110-2). In response, software application 116 triggers a link connection with a link management protocol (LMP) in a Bluetooth™ stack in networking subsystem 112-1 in electronic device 110-1. Then, the LMP initiates a synchronous connection-oriented link, an enhanced synchronous connection-oriented link and/or an A2DP link via control logic in networking subsystems 112. This results in the communication link between electronic devices 110 transitioning from the power-saving mode to the active mode (in which voice, audio and/or data packets are communicated between electronic devices 110).

After receiving confirmation that the communication link is now in the active mode, LMP conveys the confirmation to software application 116. Then, software application 116 sends the information in packets (for example, using audio or voice) to electronic device 110-2 using the communication link.

We now describe embodiments of the electronic device. FIG. 3 presents a block diagram illustrating an electronic device 300. This electronic device includes processing subsystem 310, memory subsystem 312, and networking subsystem 314. Processing subsystem 310 includes one or more devices configured to perform computational operations. For example, processing subsystem 310 can include one or more microprocessors, application-specific integrated circuits (ASICs), microcontrollers, programmable-logic devices, and/or one or more digital signal processors (DSPs).

Memory subsystem 312 includes one or more devices for storing data and/or instructions for processing subsystem 310 and networking subsystem 314. For example, memory subsystem 312 can include dynamic random access memory (DRAM), static random access memory (SRAM), and/or other types of memory. In some embodiments, instructions for processing subsystem 310 in memory subsystem 312 include: one or more program modules or sets of instructions (such as program module 324), which may be executed by processing subsystem 310. Note that the one or more computer programs may constitute a computer-program mechanism. Moreover, instructions in the various modules in memory subsystem 312 may be implemented in: a high-level procedural language, an object-oriented programming language, and/or in an assembly or machine language. Furthermore, the programming language may be compiled or interpreted, e.g., configurable or configured, to be executed by processing subsystem 310. In some embodiments, at least a portion of program module 324 includes an application tool that is embedded in the web page, and which executes in a virtual environment of a web browser. Thus, the application tool may be provided to electronic device 300 via a client-server architecture.

In addition, memory subsystem 312 can include mechanisms for controlling access to the memory. In some embodiments, memory subsystem 312 includes a memory hierarchy that comprises one or more caches coupled to a memory in electronic device 300. In some of these embodiments, one or more of the caches is located in processing subsystem 310.

In some embodiments, memory subsystem 312 is coupled to one or more high-capacity mass-storage devices (not shown). For example, memory subsystem 312 can be coupled to a magnetic or optical drive, a solid-state drive, or another type of mass-storage device. In these embodiments, memory subsystem 312 can be used by electronic device 300 as fast-access storage for often-used data, while the mass-storage device is used to store less frequently used data.

Networking subsystem 314 includes one or more devices configured to couple to and communicate on a wired and/or wireless network (i.e., to perform network operations), including: control logic 316, an interface circuit 318 and an antenna 320. For example, networking subsystem 314 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 300 may use the mechanisms in networking subsystem 314 for performing simple wireless communication between the electronic devices, e.g., transmitting advertising frames and/or scanning for advertising frames transmitted by other electronic devices.

Within electronic device 300, processing subsystem 310, memory subsystem 312, and networking subsystem 314 are coupled together using bus 328. Bus 328 may include an electrical, optical, and/or electro-optical connection that the subsystems can use to communicate commands and data among one another. Although only one bus 328 is shown for clarity, different embodiments can include a different number or configuration of electrical, optical, and/or electro-optical connections between the subsystems.

In some embodiments, the electronic device includes a display subsystem 326 for displaying information on a display, which may include a display driver and the display, such as a liquid-crystal display, a touchscreen, etc.

Electronic device 300 can be (or can be included in) any electronic device with at least one network interface. For example, electronic device 300 can be (or can be included in): a desktop computer, a laptop computer, a server, a media player (such as an MP3 player), an appliance, a subnotebook/netbook, a tablet computer, a smartphone, a cellular telephone, a piece of testing equipment, a network appliance, a set-top box, a personal digital assistant (PDA), a toy, a controller, a digital signal processor, a game console, a computational engine within an appliance, a consumer-electronic device, a portable computing device, a personal organizer, and/or another electronic device.

Although specific components are used to describe electronic device 300, in alternative embodiments, different components and/or subsystems may be present in electronic device 300. For example, electronic device 300 may include one or more additional processing subsystems 310, memory subsystems 312, networking subsystems 314, and/or display subsystems 326. Additionally, one or more of the subsystems may not be present in electronic device 300. Moreover, in some embodiments, electronic device 300 may include one or more additional subsystems that are not shown in FIG. 3. For example, electronic device 300 can include, but is not limited to: a power subsystem (such as a battery), a data collection subsystem, an audio and/or video subsystem, an alarm subsystem, a media processing subsystem, and/or an input/output (I/O) subsystem. Also, although separate subsystems are shown in FIG. 3, in some embodiments, some or all of a given subsystem or component can be integrated into one or more of the other subsystems or component(s) in electronic device 300. For example, program module 324 may be included in operating system 322.

Moreover, the circuits and components in electronic device 300 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 314, such as a radio. Moreover, the integrated circuit may include hardware and/or software mechanisms that are used for transmitting wireless signals from electronic device 300 and receiving signals at electronic device 300 from other electronic devices. Aside from the mechanisms herein described, radios are generally known in the art and hence are not described in detail. In general, networking subsystem 314 and/or the integrated circuit can include any number of radios. Note that the radios in multiple-radio embodiments function in a similar way to the described single-radio embodiments.

In some embodiments, networking subsystem 314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, etc.)

While Bluetooth™ was used as an illustrative example, the described embodiments of the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A method for communicating between an electronic device and another electronic device, wherein the method comprises:
determining a need to communicate information with the other electronic device at a future time, wherein the other electronic device was previously identified by the electronic device, and wherein a communication link between the electronic device and the other electronic device is currently in a power-saving mode;
providing a command to an interface circuit in the electronic device to transition the communication link to an active mode;
receiving a confirmation from the interface circuit that the communication link is in the active mode; and
providing the information to the interface circuit for communication to the other electronic device at the time without a time delay associated with transitioning the communication link from the power-saving mode to the active mode.

2. The method of claim 1, wherein communicating the information in the active mode involves a communication protocol; and
wherein the communication protocol includes Bluetooth™.

3. The method of claim 1, wherein communicating the information in the active mode involves a communication protocol; and
wherein the communication protocol is other than Bluetooth™.

4. The method of claim 1, wherein, in the active mode, the communication link includes a synchronous connection-oriented link.

5. The method of claim 1, wherein, in the active mode, the communication link includes an extended synchronous connection-oriented link.

6. The method of claim 1, wherein, in the active mode, the communication link is compatible with an advanced audio distribution profile.

7. The method of claim 1, wherein, in the power-saving mode, the communication link is compatible with a sniff mode in which the electronic device listens for specific commands from the other electronic device.

8. An electronic device, comprising:
an antenna;
an interface circuit, coupled to the antenna, configured to communicate with another electronic device via a communication link;
a processor; and
memory, wherein the memory stores a program module, and wherein the program module is configurable to be executed by the processor to facilitate communication between the electronic device and the other electronic device, the program module including:
instructions for determining a need to communicate information with the other electronic device at a future time, wherein the other electronic device was previously identified by the electronic device, and wherein the communication link between the electronic device and the other electronic device is currently in a power-saving mode;
instructions for providing a command to the interface circuit to transition the communication link to an active mode;
instructions for receiving a confirmation from the interface circuit that the communication link is in the active mode; and
instructions for providing the information to the interface circuit for communication to the other electronic device at the time without a time delay associated with transitioning the communication link from the power-saving mode to the active mode.

9. The electronic device of claim 8, wherein communicating the information in the active mode involves a communication protocol; and
wherein the communication protocol includes Bluetooth™.

10. The electronic device of claim 8, wherein communicating the information in the active mode involves a communication protocol; and
wherein the communication protocol is other than Bluetooth™.

11. The electronic device of claim 8, wherein, in the active mode, the communication link includes a synchronous connection-oriented link.

12. The electronic device of claim 8, wherein, in the active mode, the communication link includes an extended synchronous connection-oriented link.

13. The electronic device of claim 8, wherein, in the active mode, the communication link is compatible with an advanced audio distribution profile.

14. The electronic device of claim 8, wherein, in the power-saving mode, the communication link is compatible with a sniff mode in which the electronic device listens for specific commands from the other electronic device.

15. A computer-program product for use in conjunction with an electronic device, the computer-program product comprising a non-transitory computer-readable storage medium and a computer-program mechanism embedded therein, to facilitate communication between the electronic device and another electronic device, the computer-program mechanism including:
instructions for determining a need to communicate information with the other electronic device at a future time, wherein the other electronic device was previously identified by the electronic device, and wherein a communication link between the electronic device and the other electronic device is currently in a power-saving mode;
instructions for providing a command to an interface circuit in the electronic device to transition the communication link to an active mode;
instructions for receiving a confirmation from the interface circuit that the communication link is in the active mode; and
instructions for providing the information to the interface circuit for communication to the other electronic device at the time without a time delay associated with transitioning the communication link from the power-saving mode to the active mode.

16. The computer-program product of claim 15, wherein communicating the information in the active mode involves a communication protocol; and
wherein the communication protocol includes Bluetooth™.

17. The computer-program product of claim 15, wherein communicating the information in the active mode involves a communication protocol; and
wherein the communication protocol is other than Bluetooth™.

18. The computer-program product of claim 15, wherein, in the active mode, the communication link includes a synchronous connection-oriented link.

19. The computer-program product of claim 15, wherein, in the active mode, the communication link includes an extended synchronous connection-oriented link.

20. The computer-program product of claim 15, wherein, in the active mode, the communication link is compatible with an advanced audio distribution profile.

21. The computer-program product of claim 15, wherein, in the power-saving mode, the communication link is compatible with a sniff mode in which the electronic device listens for specific commands from the other electronic device.
